(19) United States
(12) Patent Application Publication
(10) Pub. No.: US 2026/0061578 A1
(43) Pub. Date: Mar. 5, 2026

(54) Torque wrench for adjusting sound

(71) Applicant: Zhejiang Shinman Tools Co., Ltd, Zhuji City (CN)

(72) Inventors: Jun SHAO, Zhuji City (CN); Liang HUA, Zhuji City (CN); Linwei XUE, Zhuji City (CN)

(73) Assignee: Zhejiang Shinman Tools Co., Ltd, Zhuji City (CN)

(21) Appl. No.: 18/920,903

(22) Filed: Oct. 20, 2024

(30) Foreign Application Priority Data
Sep. 2, 2024 (CN) 2024221429088

(51) Int. Cl. B25B 23/142

(52) U.S. Cl. CPC B25B 23/1427

(57) ABSTRACT

A torque wrench for adjusting sound, comprising a plastic handle, and further comprising: a main pipe, and a ratchet actuating component and a rotation limiting assembly arranged on the main pipe, wherein one end of the main pipe is rotatably connected in the plastic handle; the rotation limiting assembly comprises a plurality of sink grooves evenly arranged in an annular manner on a side wall of the main pipe, and the rotation limiting assembly is configured to limit rotation of the plastic handle relative to the main pipe; the ratchet actuating component is configured to rotate a bolt, and the rotating plastic handle adjusts the preset torque of the actuating component; a placement hole is arranged on a side wall of the plastic handle, and a first steel ball and a small spring are arranged in the placement hole.

### INCORPORATION BY REFERENCE

This application claims the benefit of priority from China Patent Application No. 2024221429088 filed on Sep. 2, 2024, the contents of which are hereby incorporated by reference in their entirety.

### TECHNICAL FIELD

The present invention belongs to the technical field of torque wrenches, in particular to a torque wrench for adjusting sound.

### BACKGROUND ART

A torque wrench is a type of wrench. Wherein, the mechanical sound alarm type adopts the lever principle. When the torque reaches the set torque, there will be a “bang” sound of mechanical collision, and then the wrench will become a dead corner. If exerting more force, over-force will occur.

When tightening bolts of different materials and specifications, different torques need are required, that it is necessary to adjust the preset torque of the torque wrench. The preset torque of the torque wrench can be adjusted by relative rotation of the handle and the execution part.

The torque scale is generally provided on the existing torque wrenches, so it is convenient to understand the torque adjustment by observing the scale, However, in a dark environment or an environment where it is not convenient to observe the torque scale, it is difficult to understand the torque adjustment by observing the torque scale, which is not convenient to use.

### SUMMARY OF THE INVENTION

The purpose of the embodiment of the present invention is to provide a torque wrench for adjusting sound, which aims to solve the problem that in a dark environment or an environment where it is not convenient to observe the torque scale, it is difficult to understand the torque adjustment by observing the torque scale.

The present invention is implemented as follows, a torque wrench for adjusting sound, comprising a plastic handle, wherein further comprising: a main pipe, and a ratchet actuating component and a rotation limiting assembly arranged on the main pipe, wherein one end of the main pipe is rotatably connected in the plastic handle; the rotation limiting assembly comprises a plurality of sink grooves evenly arranged in an annular manner on a side wall of the main pipe, and the rotation limiting assembly is configured to limit rotation of the plastic handle relative to the main pipe; the ratchet actuating component is configured to rotate a bolt, and the rotating plastic handle adjusts the preset torque of the actuating component; and a placement hole is arranged on a side wall of the plastic handle, a first steel ball and a small spring are arranged in the placement hole, and the small spring pushes the first steel ball to press against the side wall of the main pipe.

As a further technical solution, the rotation limiting component further comprises a circular hole arranged on the side wall of the plastic handle, and a second steel ball is movably connected in the circular hole; a lock catch is movably sleeved onto the plastic handle, and when an inner wall of the lock catch contacts the second steel ball, the second steel ball is located in the sink grooves and the circular hole on the side wall of the plastic handle; and an annular receiving groove is arranged on an inner wall of the lock catch, and when the annular receiving groove and the second steel ball coincide, the plastic handle rotating relatively to the main pipe pushes the second steel ball into the annular receiving groove and the circular hole on the side wall of the plastic handle.

As a further technical solution, a connecting piece is fixed to one end of the plastic handle close to the main pipe; the connecting piece is configured to limit the lock catch from being detached from the one end close to the main pipe; the one end for limiting the lock catch from moving away from the connecting piece is fixedly connected with a lock catch spring, and a tail end of the lock catch spring is fixed to the plastic handle; and mounting sink grooves are provided on the side wall of the plastic handle, and elastic steel wires are provided in the mounting sink grooves, and two annular positioning grooves are provided on the inner wall of the lock catch, and the elastic steel wires cooperate with the two annular positioning grooves.

As a further technical solution, a secondary scale ring is fixedly connected to one end of the connecting piece away from the plastic handle, and the secondary scale ring and the connecting piece are both movably sleeved onto the main pipe.

As a further technical solution, the ratchet actuating component comprises a ratchet handle, the ratchet handle is rotatably connected in the main pipe through a retaining pin, and a nut is fixed in the main pipe through a pin; and a nut insert is slidably connected in the plastic handle, a screw is fixed on the nut insert, the screw penetrates and is threadedly connected in the nut, a gasket is rotatably connected with one end of the nut close to the main pipe, and a main spring and a slider block are sequentially arranged between the gasket and the ratchet handle.

As a further technical solution, a tail cover is pluggably connected with one end of the plastic handle away from the main pipe.

Compared with the prior art, the beneficial effects of the present invention are as follows:

The rotating plastic handle drives the small spring and the first steel ball to rotate relative to the main pipe. Since the small spring pushes the first steel ball against the side wall of the main pipe, the first steel ball will frequently enter and escape from the sink grooves when moving on the side wall of the main pipe. When the first steel ball contacts the irregular side wall of the main pipe, there will be a “ka” sound, so that the adjustment of the preset torque value of the ratchet actuating component can be understood through the sound of the first steel ball's contacting the irregular side wall of the main pipe. Compared with the existing method of adopting an observation scale to understand the adjustment of the preset torque of the torque wrench, the present invention can understand the adjustment of the preset torque of the torque wrench in a dark environment or an environment where it is not convenient to observe the torque scale, which thereby facilitates the use of the torque wrench.

### DESCRIPTION OF DRAWINGS

FIG. 1 is a structural diagram of a torque wrench for adjusting sound provided by the present invention;

FIG. 2 is a structural diagram of FIG. 1 provided by the present invention from a top view angle;

FIG. 3 is an internal structural diagram of a main pipe and a plastic handle in FIG. 1 provided by the present invention;

FIG. 4 is a structural diagram of a secondary scale ring and a connecting piece in FIG. 1 provided by the present invention;

FIG. 5 is a structural diagram of the secondary scale ring and the connecting piece in FIG. 5 provided by the present invention from another perspective;

FIG. 6 is a structural diagram of the connecting piece and the plastic handle in FIG. 1 provided by the present invention;

FIG. 7 is a structural diagram of a lock catch and the plastic handle in FIG. 1 provided by the present invention;

FIG. 8 is a structural diagram of the lock catch and the plastic handle in FIG. 1 provided by the present invention from another perspective;

FIG. 9 is an internal structural diagram of the lock catch in FIG. 1 provided by the present invention; and

FIG. 10 is a structural diagram of the plastic handle and a tail cover in FIG. 1 provided by the present invention.

In the drawings: 1—driving block; 2—ratchet handle; 3—reversing button; 4—retaining pin; 5—main pipe; 501—sink groove; 6—secondary scale ring; 601—positioning groove; 602—positioning annular groove; 7—connecting piece; 701—positioning protrusion; 702—elastic clamping groove; 703—positioning buckle; 704—positioning slot; 8—lock catch; 801—annular receiving groove; 802—annular positioning groove; 9—main spring; 10—plastic handle; 1001—mounting sink groove; 1002—elastic steel wire; 1003—positioning clamping piece; 1004—positioning plug; 1005—positioning groove; 1006—limiting groove; 11—pin; 12—screw; 13—nut insert; 14—tail cover; 1401—limiting buckle; 1402—limiting protrusion; 1403—maintenance groove; 15—nut; 16—gasket; 17—first steel ball; 18—small spring; 19—lock catch spring; and 20—second steel ball.

### EMBODIMENTS

Hereinafter, in order to make the purpose, technical solution and advantages of the present invention more clear, the present invention is further described in detail in combination with the accompanying drawings and embodiments. It should be understood that the specific embodiments described herein are only for explaining the present invention and are not intended to limit the present invention.

The specific implementation of the present invention is described in detail in combination with the specific embodiments.

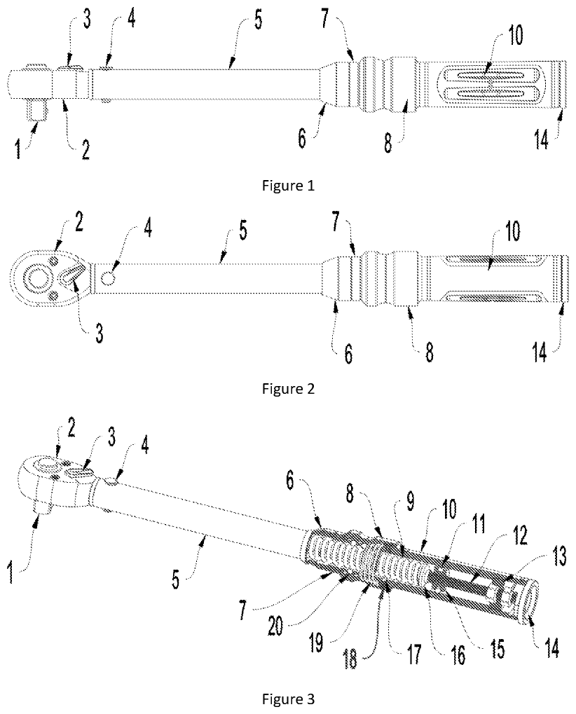

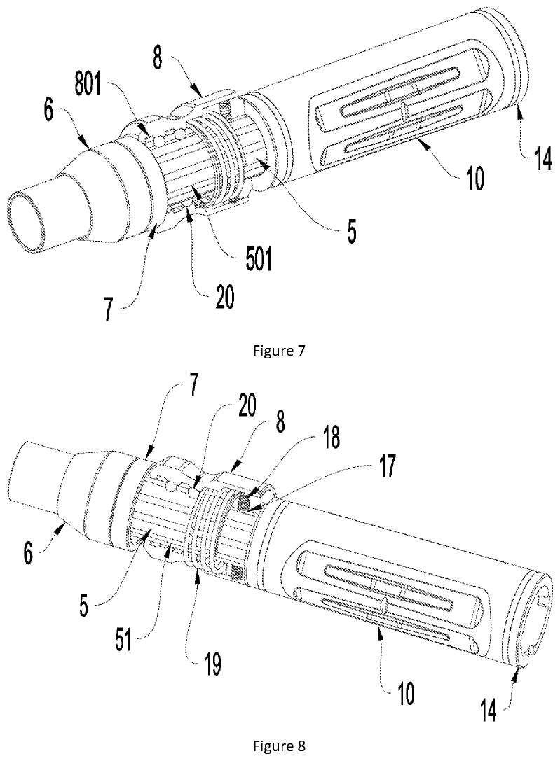

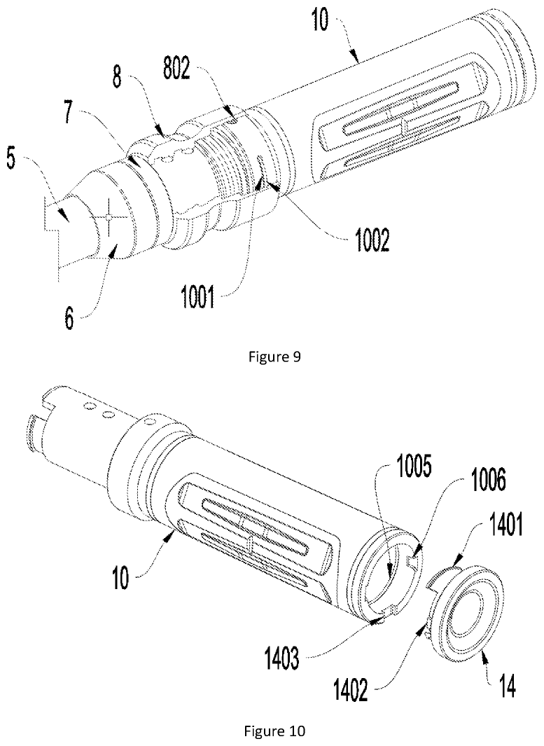

As shown in FIGS. 1, 2, 3, 7, 8 and 9, a torque wrench for adjusting sound provided by an embodiment of the present invention, comprising a plastic handle 10, wherein further comprising: a main pipe 5, and a ratchet actuating component and a rotation limiting assembly arranged on the main pipe 5, wherein one end of the main pipe 5 is rotatably connected in the plastic handle 10; the rotation limiting assembly comprises a plurality of sink grooves 501 evenly arranged in an annular manner on a side wall of the main pipe 5, and the rotation limiting assembly is configured to limit rotation of the plastic handle 10 relative to the main pipe 5; the ratchet actuating component is configured to rotate a bolt, and the rotating plastic handle 10 adjusts the preset torque of the actuating component; and a placement hole is arranged on a side wall of the plastic handle 10, a first steel ball 17 and a small spring 18 are arranged in the placement hole, and the small spring 18 pushes the first steel ball 17 to press against the side wall of the main pipe 5.

In the embodiment of the present invention, when the preset torque value of the torque wrench is adjusted, the rotation limiting assembly releases the restriction on the rotation of the plastic handle 10 relative to the main pipe 5, and the plastic handle 10 is rotated, the rotating plastic handle 10 adjusts the preset torque of the ratchet actuating component. The rotating plastic handle 10 further drives the small spring 18 and the first steel ball 17 to rotate relative to the main pipe 5. Since the small spring 18 pushes the first steel ball 17 against the side wall of the main pipe 5, the first steel ball 17 will frequently enter and escape from the sink grooves 501 when moving on the side wall of the main pipe 5. When the first steel ball 17 contacts the irregular side wall of the main pipe 5, there will be a “ka” sound, so that the adjustment of the preset torque value of the ratchet actuating component can be understood through the sound of the first steel ball's 17 contacting the irregular side wall of the main pipe 5. Compared with the existing method of adopting an observation scale to understand the adjustment of the preset torque of the torque wrench, the present invention can understand the adjustment of the preset torque of the torque wrench in a dark environment or an environment where it is not convenient to observe the torque scale, which thereby facilitates the use of the torque wrench.

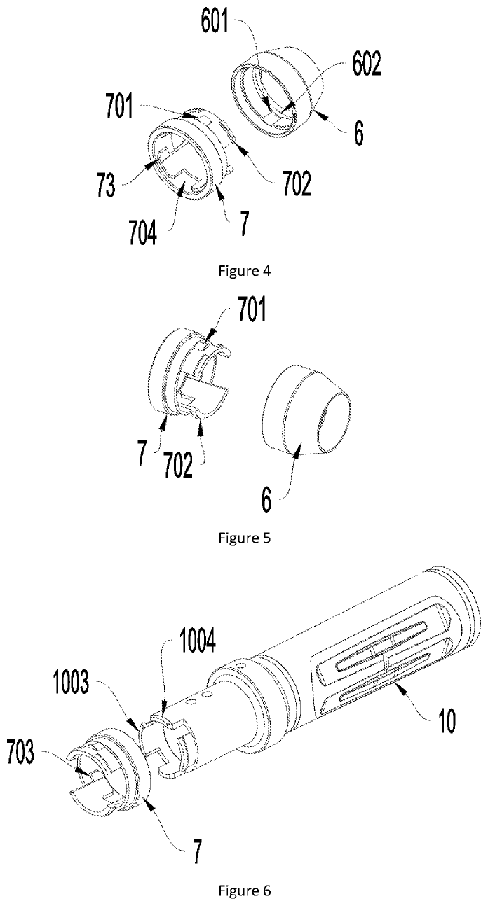

As shown in FIGS. 1 to 9, as a preferred embodiment of the present invention, the rotation limiting component further comprises a circular hole arranged on the side wall of the plastic handle 10, a second steel ball 20 is movably connected in the circular hole, and the diameter of the second steel ball 20 is equal to the sum of the thickness of the side wall of the plastic handle 10 and the depth of the sink grooves 501; a lock catch 8 is movably sleeved onto the plastic handle 10, and when an inner wall of the lock catch 8 contacts the second steel ball 20, the second steel ball 20 is located in the sink grooves 501 and the circular hole on the side wall of the plastic handle 10; an annular receiving groove 801 is arranged on an inner wall of the lock catch 8, and the depth of the annular receiving groove 801 is less than the diameter of the second steel ball 20, and when the annular receiving groove 801 and the second steel ball 20 coincide, the plastic handle 10 rotating relatively to the main pipe 5 pushes the second steel ball 20 into the annular receiving groove 801 and the circular hole on the side wall of the plastic handle 10, the diameter of the second steel ball 20 is respectively greater than the thickness of the side wall of the lock catch 8, the depth of the sink grooves 501 and the depth of the annular receiving groove 801; a connecting piece 7 is fixed to one end of the plastic handle 10 close to the main pipe 5, a positioning buckle 703 and a positioning slot 704 is arranged on the inner wall of the connecting piece 7, one end of the plastic handle 10 close to the connecting piece 7 is fixed with a positioning clamping piece 1003 and a positioning plug 1004, the positioning plug 1004 is inserted into the positioning slot 704 to limit the relative rotation of the connecting piece 7 and the plastic handle 10, the positioning clamping piece 1003 hooks the positioning buckle 703 to limit the relative distance between the connecting piece 7 and the plastic handle 10; the connecting piece 7 is configured to limit the lock catch 8 from being detached from the one end close to the main pipe 5; the one end for limiting the lock catch 8 from moving away from the connecting piece 7 is fixedly connected with a lock catch spring 19, and a tail end of the lock catch spring 19 is fixed to the plastic handle 10; and mounting sink grooves 1001 are provided on the side wall of the plastic handle 10, and elastic steel wires 1002 are provided in the mounting sink grooves 1001, the mounting sink grooves 1001 and the elastic steel wires 1002 are both provided with two, and two annular positioning grooves 802 are provided on the inner wall of the lock catch 8, and the elastic steel wires 1002 cooperate with the two annular positioning grooves 802.

In the embodiment of the present invention, in the initial state, the lock catch spring 19 pushes the lock catch 8, the lock catch 8 is against the connecting piece 7, the inner wall of the lock catch 8 contacts the second steel ball 20, the elastic steel wires 1002 are clamped in one of the annular positioning grooves 802, and the second steel ball 20 is in the sink grooves 501 and the circular hole arranged on the side wall of the plastic handle 10, so that the second steel ball 20 restricts the main pipe 5 and the plastic handle 10 from rotating relative to each other; the lock catch 8 is pulled away from the main pipe 5, and the lock catch 8 overcomes the elastic force of the lock catch spring 19 and moves until the elastic steel wires 1002 are clamped in another annular positioning groove 802, which can prevent the lock catch spring 19 from pushing the lock catch 8 to move in an opposite direction and reset, and when the annular receiving groove 801 coincides with the second steel ball 20, the plastic handle 10 rotating relative to the main pipe 5 pushes the second steel ball 20 into the annular receiving groove 801 and the circular hole arranged on the side wall of the plastic handle 10, which releases the restriction on the relative rotation of the main pipe 5 and the plastic handle 10; when the main pipe 5 and the plastic handle 10 are fixedly connected again, the lock catch 8 is pushed in a reverse direction, and with the assistance of the elastic force of the lock catch spring 19, the lock catch 8 is pressed against the connecting piece 7, and the inner wall of the lock catch 8 contacts the second steel ball 20, the inner wall of the lock catch 8 pushes the second steel ball 20 into the sink grooves 501 and the circular hole arranged on the side wall of the plastic handle 10, and the elastic steel wires 1002 are clamped in one of the mounting sink grooves 1001.

As shown in FIGS. 1 to 5, as a preferred embodiment of the present invention, a secondary scale ring 6 is fixedly connected to one end of the connecting piece 7 away from the plastic handle 10, and the secondary scale ring 6 and the connecting piece 7 are both movably sleeved onto the main pipe 5, a positioning groove 601 and a positioning annular groove 602 are arranged on an inner wall of the secondary scale ring 6, and a positioning protrusion 701 and an elastic clamping groove 702 are arranged on the side wall of the connecting piece 7 close to one end of the secondary scale ring 6, the positioning protrusion 701 is inserted into the positioning groove 601 to limit the relative rotation of the secondary scale ring 6 and the connecting piece 7, and the elastic clamping groove 702 is clamped in the positioning annular groove 602 to limit the relative distance between the secondary scale ring 6 and the connecting piece 7.

In the embodiment of the present invention, a torque scale can be provided on the side wall of the secondary scale ring 6 or the main pipe 5, when adjusting the preset torque value of the torque wrench, the rotating plastic handle 10 drives the connecting piece 7 to rotate, and the connecting piece 7 drives the secondary scale ring 6 to rotate, and when the secondary scale ring 6 rotates relative to the main pipe 5, the change of the preset torque value of the torque wrench shall be observed.

As shown in FIGS. 1 to 3, as a preferred embodiment of the present invention, the ratchet actuating component comprises a ratchet handle 2, the ratchet handle 2 is rotatably connected in the main pipe 5 through a retaining pin 4, and a nut 15 is fixed in the main pipe 5 through a pin 11; and a nut insert 13 is slidably connected in the plastic handle 10, a screw 12 is fixed on the nut insert 13, the screw 12 penetrates and is threadedly connected in the nut 15, a gasket 16 is rotatably connected with one end of the nut 15 close to the main pipe 5, and a main spring 9 and a slider block are sequentially arranged between the gasket 16 and the ratchet handle 2, a driving block 1 and a reversing button 3 are respectively installed at both ends of the ratchet handle 2, and the driving block 1 can be connected with sleeves of various specifications.

In the embodiment of the present invention, the internal structure of the ratchet handle 2 and the structure between the ratchet handle 2 and the main spring 9 all adopt the prior art, which will not be repeated in the present invention. The preset torque value of the ratchet handle 2 is adjusted by changing the compression degree of the main spring 9; when adjusting the ratchet handle 2 and the preset torque value, the plastic handle 10 is rotated, and the plastic handle 10 drives the nut insert 13 to rotate, and the nut insert 13 drives the screw 12 to rotate, the rotating screw 12 moves on the nut 15 through thread transmission, so that the screw 12 adjusts the compression amount of the main spring 9. When the rotating screw 12 moves relative to the nut 15, the screw 12 drives the nut insert 13 to move in the plastic handle 10, the matching cross-section of the nut insert 13 and the inner wall of the plastic handle 10 adopts a regular polygon, and the nut insert 13 can only move in the plastic handle 10 and cannot rotate.

As shown in FIG. 10, as a preferred embodiment of the present invention, a tail cover 14 is pluggably connected with one end of the plastic handle 10 away from the main pipe 5, a positioning groove 1005 and a limiting groove 1006 are provided at one end of the plastic handle 10 away from the main pipe 5, and a limiting buckle 1401 and a limiting protrusion 1402 are provided at one end of the tail cover 14 close to the plastic handle 10, the limiting buckle 1401 hooks the positioning groove 1005 to limit the tail cover 14 from being away from the plastic handle 10, and the limiting protrusion 1402 is inserted into the limiting groove 1006 to limit the tail cover 14 from rotating on the plastic handle 10, a maintenance groove 1403 is provided on the plastic handle 10.

In the embodiment of the present invention, the tail cover 14 can be opened and the inside of the plastic handle 10 can be repaired by inserting a tool into the maintenance groove 1403.

The above are only preferred embodiments of the present invention and are not intended to limit the present invention. Any modification, equivalent replacement and improvement made within the spirit and principle of the present invention shall fall within the protection scope of the present invention.

1. A torque wrench for adjusting sound, comprising a plastic handle, wherein further comprising:
a main pipe, and a ratchet actuating component and a rotation limiting assembly arranged on the main pipe, wherein one end of the main pipe is rotatably connected in the plastic handle;
the rotation limiting assembly comprises a plurality of sink grooves evenly arranged in an annular manner on a side wall of the main pipe, and the rotation limiting assembly is configured to limit rotation of the plastic handle relative to the main pipe;
the ratchet actuating component is configured to rotate a bolt, and the rotating plastic handle adjusts the preset torque of the actuating component; and
a placement hole is arranged on a side wall of the plastic handle, a first steel ball and a small spring are arranged in the placement hole, and the small spring pushes the first steel ball to press against the side wall of the main pipe.

2. The torque wrench for adjusting sound according to claim 1, wherein the rotation limiting component further comprises a circular hole arranged on the side wall of the plastic handle, and a second steel ball is movably connected in the circular hole;
a lock catch is movably sleeved onto the plastic handle, and when an inner wall of the lock catch contacts the second steel ball, the second steel ball is located in the sink grooves and the circular hole on the side wall of the plastic handle; and
an annular receiving groove is arranged on an inner wall of the lock catch, and when the annular receiving groove and the second steel ball coincide, the plastic handle rotating relatively to the main pipe pushes the second steel ball into the annular receiving groove and the circular hole on the side wall of the plastic handle.

3. The torque wrench for adjusting sound according to claim 2, wherein a connecting piece is fixed to one end of the plastic handle close to the main pipe;
the connecting piece is configured to limit the lock catch from being detached from the one end close to the main pipe;
the one end for limiting the lock catch from moving away from the connecting piece is fixedly connected with a lock catch spring, and a tail end of the lock catch spring is fixed to the plastic handle; and
mounting sink grooves are provided on the side wall of the plastic handle, and elastic steel wires are provided in the mounting sink grooves, and two annular positioning grooves are provided on the inner wall of the lock catch, and the elastic steel wires cooperate with the two annular positioning grooves.

4. The torque wrench for adjusting sound according to claim 3, wherein a secondary scale ring is fixedly connected to one end of the connecting piece away from the plastic handle, and the secondary scale ring and the connecting piece are both movably sleeved onto the main pipe.

5. The torque wrench for adjusting sound according to claim 1, wherein the ratchet actuating component comprises a ratchet handle, the ratchet handle is rotatably connected in the main pipe through a retaining pin, and a nut is fixed in the main pipe through a pin; and
a nut insert is slidably connected in the plastic handle, a screw is fixed on the nut insert, the screw penetrates and is threadedly connected in the nut, a gasket is rotatably connected with one end of the nut close to the main pipe, and a main spring and a slider block are sequentially arranged between the gasket and the ratchet handle.

6. The torque wrench for adjusting sound according to claim 1, wherein a tail cover is pluggably connected with one end of the plastic handle away from the main pipe.
